(19) United States
(12) Patent Application Publication
(10) Pub. No.: US 2018/0143827 A1
(43) Pub. Date: May 24, 2018

(54) Operation Cell Data Processor Systems and Methods

(71) Applicant: David Raymond Hentrich, Kildeer, IL (US)

(72) Inventor: David Raymond Hentrich, Kildeer, IL (US)

(21) Appl. No.: 15/844,810

(22) Filed: Dec. 18, 2017

(51) Int. Cl. G06F 9/22; G06F 9/30

(52) U.S. Cl. CPC G06F 9/226; G06F 9/3885; G06F 9/3001; G06F 9/30043

(57) ABSTRACT

Computer program instruction oriented data processor logic cell that independently determines when its instruction should be processed, data processors made of the aforementioned logic cells, networks made of the aforementioned data processors, and methods of operating the aforementioned.

### BACKGROUND

The following is a tabulation of some prior art that presently appears relevant:

### U.S. Patents

| Patent Number | Issue Date | Patentee |
|---|---|---|
| 3,287,703 | 1966 Nov. 22 | Slotnick |
| 3,473,160 | 1969 Oct. 14 | Wahlstrom |
| 3,544,973 | 1970 Dec. 01 | Borck |
| 3,815,095 | 1974 Jun. 04 | Wester |
| 3,820,079 | 1974 Jun. 25 | Hamilton et al. |
| 3,979,728 | 1976 Sep. 7 | Reddaway |
| 4,558,236 | 1985 Dec. 10 | Burrows |
| 4,564,857 | 1987 Mar. 31 | Samson et al. |
| 4,706,216 | 1987 Nov. 10 | Carter |
| 4,873,626 | 1989 Oct. 10 | Gifford |
| 4,905,142 | 1990 Feb. 27 | Takahashi et al. |
| 4,933,895 | 1990 Jun. 12 | Grinberg et al. |
| 4,943,912 | 1990 Jul. 24 | Aoyama et al. |
| 5,963,746 | 1999 Oct. 5 | Barker et al. |
| 5,115,510 | 1992 May 19 | Okamoto et al. |
| 5,065,308 | 1991 Nov. 12 | Evans |
| 5,386,154 | 1995 Jan. 31 | Goetting et al. |
| 5,784,636 | 1998 Jul. 21 | Rupp |
| 5,426,378 | 1995 Jun. 20 | Ong |
| 5,600,845 | 1997 Feb. 4 | Gilson |
| 5,717,943 | 1998 Feb. 10 | Barker et al. |
| 5,765,015 | 1998 Jun. 9 | Wilkinson |
| 6,058,469 | 2000 May 2 | Baxter |
| 6,145,072 | 2000 Nov. 7 | Shams et al. |
| 6,167,501 | 2000 Dec. 26 | Barry et al. |
| 6,738,891 | 2004 May 18 | Fujii et al. |
| 6,449,708 | 2002 Sep. 10 | Dewhurst et al. |
| 7,191,312 | 2007 Mar. 13 | Ikeda et al. |
| 7,782,087 | 2010 Aug. 24 | Vorbach |
| 8,058,899 | 2011 Nov. 15 | Vorbach et al. |
| 8,471,593 | 2013 Jun. 25 | Vorbach et al. |
| 8,516,225 | 2013 Aug. 20 | Kitagishi et al. |
| 9,037,807 | 2015 Apr. 19 | Vorbach |

### World Intellectual Property Organization Applications

| Application Number | Publication Date | Applicant |
|---|---|---|
| 200453718A1 | 2004 Jun. 24 | Stefan et al. |

Data processors are apparatuses that take one or more pieces of data, perform one or more functions on that data, and output one or more pieces of result data. Data processors have been known in the art in mechanical form for centuries, such as the Greek Antikythera Mechanism, Pascal's calculator, Charles Babbage's Difference Engine, Konrad Zuse's Z1 Computer, and Curt Herzstark's Curta Calculator. Data processors have also been known to have been constructed electromechanically, such as the Harvard Mark I. However, predominantly today, data processors are constructed using solid state electronics. Examples of modern data procesors are Intel's i7 processors, AMD's Ryzen processors, Qualcomm's Snapdragon processors, nVidia's Graphic Processing Units (GPUs), Texas Instrument's Digital Signal Processors (DSPs), Xilinx' Field Programmable Gate Arrasy (FPGAs), Samsung's Exynos Mobile Processors, China's ShenWei processor, and large numbers of microcontrollers by companies such as Zilog, ST, Infineon, Renesas, Microchip, and NXP. There are also efforts in progress to construct data processors from photonic (i.e. light) components and components that are designed to exploit features of quantum mechanics.

For the later half of the 20th century and the very early years of the 21st century, data processor speeds increased exponentially at a pace that was commonly described as Moore's Law. Unfortunately, the pace of increasing data processor speeds has slowed dramatically in recent years. New technological innovations are required to increase the speed of data processors.

Data processors that are able to execute programs that are composed of a stream of instructions are generally referred to as general purpose computers, general purpose data processors, or general purpose processors. Processors such as Intel's i7 processors, AMD's Ryzen processors, Qualcomm's Snapdragon processors, nVidia's GPUs, Texas Instrument's DSPs, and microcontrollers are examples of these kinds of general purpose computers. More examples of general purpose computers are U.S. Pat. No. 8,516,225 to Kitagishi el al., U.S. Pat. No. 3,287,703 to Slotnick, U.S. Pat. No. 3,820,079 to Hamilton et al., U.S. Pat. No. 4,654,857 to Samson et al., and U.S. Pat. No. 5,115,510A to Okamoto.

Gate Arrays are collections of general logic cells. Logic is the underlying circuit elements of a data processor. A logic cell is a collection of logic to perform one or more functions. Logic cells are also a type of data processor component. A general logic cell is a logic cell that has the possibility to perform many possible functions, but does not perform a particular function until it has been configured. Examples of general logic cells are shown in U.S. Pat. No. 8,058,899 to Vorbach et al., U.S. Pat. No. 8,471,593 to Vorbach et al., U.S. Pat. No. 5,065,308 to Evans, U.S. Pat. No. 5,386,154 to Goetting et al., U.S. Pat. No. 4,706,216 to Carter, and U.S. Pat. No. 4,558,236 to Burrows. General logic cells are also a type of data processor component.

Field Programmable Gate Arrays (FPGAs) are arrangements of configurable general logic cells and configurable communication links between these general logic cells. Some FPGAs can be configured to be general purpose data processors that can execute a set of computer program instructions. Examples of FPGAs are exhibited in U.S. Pat. No. 6,449,7088 to Dewhurst et al., U.S. Pat. No. 7,191,312 to Ikeda et al., U.S. Pat. No. 5,426,378 to Ong., and U.S. Pat. No. 5,600,845 to Gilson.

Reconfigurable general purpose processors are general purpose computers whose underlying components can be re-configured for some computational advantage. Examples of reconfigurable computers are shown in U.S. Pat. No. 6,058,469 to Baxter, U.S. Pat. No. 5,784,636 to Rupp, U.S. Pat. No. 3,544,973 to Borck et al., and U.S. Pat. No. 9,037,807 to Vorbach.

Array data processors are data processors that are themselves composed of a connected network of data processors. Examples of array data processors and their components are WO Application 2004053718 by Stefan et al., and U.S. Pat. No. 6,738,891 to Fujii et al., U.S. Pat. No. 6,145,072 to Shams et al., U.S. Pat. No. 6,167,501 to Barry et al., U.S. Pat. No. 4,905,143 to Takahashi et al., U.S. Pat. No. 5,765,015 to Wilkinson et al., U.S. Pat. No. 5,963,746 to Barker et al., U.S. Pat. No. 4,943,912 to Aoyama et al., U.S. Pat. No. 4,933,895 to Grinberg et al., U.S. Pat. No. 4,873,626 to Gifford, U.S. Pat. No. 3,979,728 to Reddaway, U.S. Pat. No. 3,815,095 to Wester, U.S. Pat. No. 3,473,160 to Wahlstrom, and U.S. Pat. No. 5,717,943 to Barker et al.

In general, to achieve future speed increases in data processors, improvements need to be made to the aforementioned technologies.

### SUMMARY

The present invention is directed to systems and methods that satisfy the need to increase the speed of data processors.

One embodiment is directed towards a logic cell that holds computer instruction data and independently determines when its associated computer instructions should execute. This logic cell embodiment is a type of operation cell.

Another embodiment is directed towards a data processor comprised of operation cells.

Another embodiment is directed towards a network of data processors that are comprised of data processors that are comprised of operation cells.

Another embodiment is directed towards a method for executing a computer instruction in a data processor comprised of operation cells.

Another embodiment is directed towards a method of forwarding the responsibility to execute an instruction from one operation cell to another operation cell in a data processor system.

Another embodiment is directed towards a method of determining the storage location for the result of an instruction execution in a data processor system comprised of operation cells.

These and other features, aspects, and advantages of the present invention will become better understood with reference to the following description and appended claims.

### BRIEF DESCRIPTION OF THE DRAWINGS

FIG. 1 shows a block diagram of an embodiment of an operation cell.

FIG. 2 shows a block diagram of an embodiment of an operation cell.

FIG. 3 shows a block diagram of an embodiment of an operation cell data processor.

FIG. 4 shows a block diagram of an embodiment of an operation cell data processor.

FIG. 5 shows a block diagram of an embodiment of an operation cell data processor.

FIG. 6 shows a block diagram of an embodiment of a network of operation cell data processors.

FIG. 7 shows a block diagram of an embodiment of a network of operation cell data processors.

FIG. 8 shows a block diagram of an embodiment of a network of operation cell data processors.

FIG. 9 shows a flow chart of an embodiment of a method to execute instructions in an operation cell data processor.

FIG. 10 shows a flow chart of an embodiment of a method to forward the instruction execution responsibility from one operation cell to another in a network of operation cell data processors.

FIG. 11 shows a flow chart of an embodiment of a method for handling the rejection of an operation cell instruction forwarding in a network of operation cell data processors.

FIG. 12 shows a flow chart of an embodiment of a method for storing the results of an instruction execution in an operation cell data processor.

FIG. 13 shows a flow chart of an embodiment of a method for storing the results of an instruction execution in an operation cell data processor

FIG. 14 shows a flow chart of an embodiment of a method for storing the results of an instruction execution in an operation cell data processor where a storage request was denied.

### DETAILED DESCRIPTION

In the Summary above and in the Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extend possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contains only) components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps (except where the context excludes that possibility).

The term “at least” followed by a number is used herein to denote the start of a range beginning with that number (which may be a range having an upper limit or no upper limit, depending on the variable being defined). For examples, “at least 1” means 1 or more than 1.

The term “operation cell” is used herein to denote a computer program instruction oriented logic cell that that independently determines when its associated instructions are ready to execute. When it has been determined that an instruction is ready to execute, it is said that the instruction has fired or it is said that the operation cell has fired. Operation cells can be used as data processor components which distribute the instruction firing decisions throughout a data processor and generally allow for more opportunities to perform parallel instruction processing than data processors with centralized instruction firing decision units. Additionally, operation cells can be used to forward instruction execution responsibilities from itself to another operation cell in the same data processor or in another data processor. This also presents the opportunity to distribute a program around one or more data processors and provides more opportunities to execute the instructions of that program in parallel. Creating additional parallel execution opportunities in data processors increases the potential speed of those data processors.

One embodiment is directed to a data processor component that comprises one or more computer program instruction data memories, memory, logic to determine when the instructions associated with the component should execute, and logic to interface to other processing elements in a data processing system. This embodiment satisfies the need to make instruction oriented logic cells and the need to make decentralized instruction execution firing decisions in a data processor system. This embodiment is type of operation cell.

Another embodiment is directed to a data processor comprising one or more operation cells, one or more arithmetic logic units, at least one input unit, and at least one output unit. This embodiment satisfies the need for a data processor with decentralized instruction execution firing decisions and the need to make a general purpose computation device. This embodiment is a type of operation cell data processor.

Another embodiment is directed to a network of operation cell data processors. This embodiment satisfies the need to make larger data processors with decentralized execution firing decisions. This embodiment also enables the responsibility of instruction executions to be moved between individual operation cell data processors and increase parallel execution opportunities.

Another embodiment is directed to a method for an operation cell to trigger the execution of an instruction.

Another embodiment is directed to a method for forwarding the handling of an instruction from a source operation cell to another operation cell.

Another embodiment is directed to a method of handling the rej ection of the forwarding of the handling of an instruction by a destination operation cell to a source operation cell.

Another embodiment is directed to a method of determining the location to store the results of an instruction in an operation cell data processor.

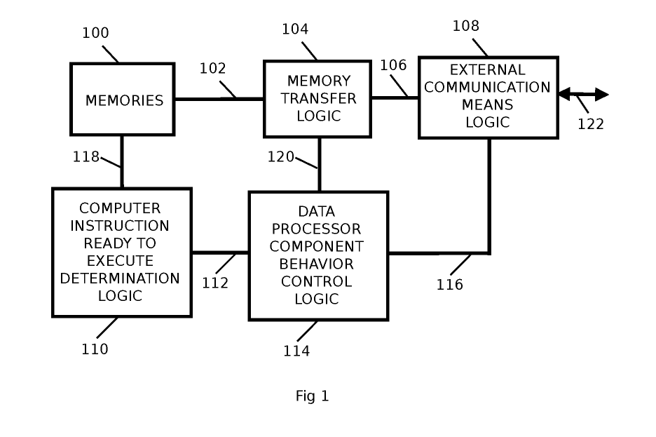

FIG. 1 illustrates an embodiment of an operation cell. It comprises one or more memories 100 that hold data related to the operation cell instructions, logic 110 to determine when an instruction is ready to execute, logic 114 to control the behavior of the operation cell, logic 104 to transfer memory data into and out of the memories 100, and logic 108 to connect the operation cell to data processor components that are outside of the operation cell. The memories 100 are connected to to the “ready to execute” logic 110 through connection 118 and are connected to the memory transfer logic 104 through connection 102. The behavior control logic 114 is connected to the “ready to execute” logic 110 through connection 112, to the memory transfer logic 104 through connection 120, and to the external connection logic 108 through connection 116. Connection 106 allows communication between the memory transfer logic 104 and the external connection logic 108. Connection 122 connects the external connection logic 108 to data processor elements outside of the operation cell.

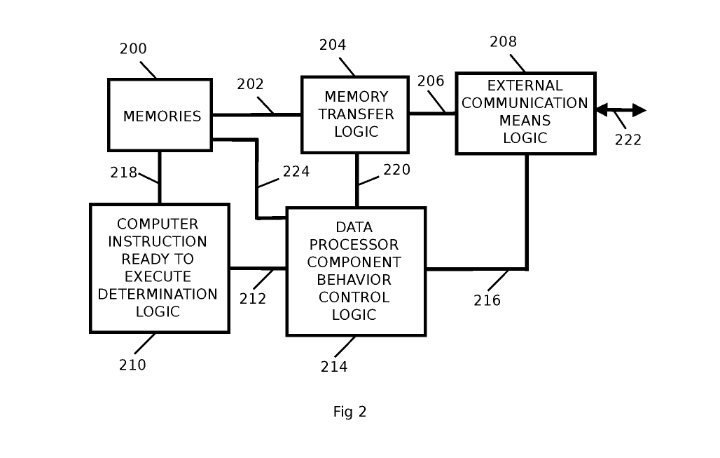

FIG. 2 illustrates an embodiment of an operation cell. It comprises one or more memories 200 that hold data related to the operation cell instructions, logic 210 to determine when an instruction is ready to execute, logic 214 to control the behavior of the operation cell, logic 204 to transfer memory data into and out of the memories 200, and logic 208 to connect the operation cell to data processor components that are outside of the operation cell. The memories 200 are connected to to the “ready to execute” logic 210 through connection 218, are connected to the memory transfer logic 204 through connection 202, and are connected to the operation cell behavior control logic 214 through connection 224. The behavior control logic 214 is connected to the “ready to execute” logic 210 through connection 212, to the memory transfer logic 204 through connection 220, and to the external connection logic 208 through connection 216. Connection 206 allows communication between the memory transfer logic 204 and the external connection logic 208. Connection 222 connects the external connection logic 208 to data processor elements outside of the operation cell.

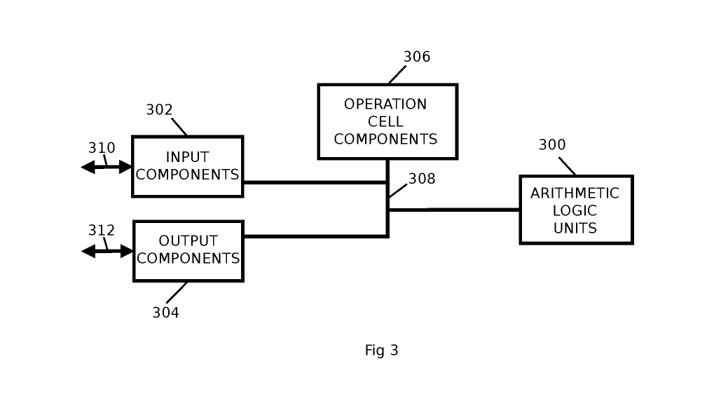

FIG. 3 illustrates an embodiment of an operation cell data processor. It comprises one or more operation cells 306, one or more arithmetic logic units 300, one or more input components 302, and one or more output components 304. The operation cells 306, arithmetic units 300, input components 302, and output components 304 are connected by communication means 308. Examples of communications means are discrete signal lines, point-to-point serial connections, traditional microprocessor buses, crossbar buses, Ethernet, and photonic communication links.

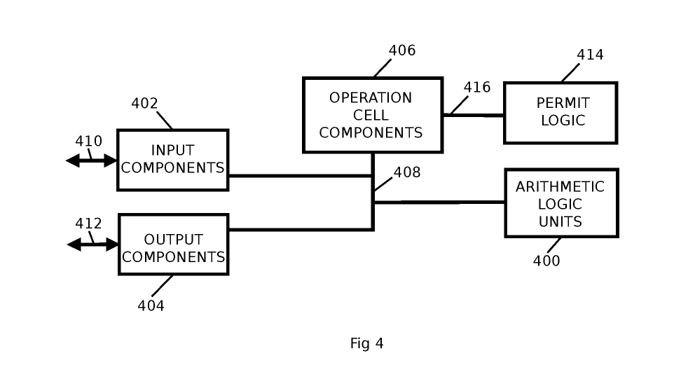

FIG. 4 illustrates an embodiment of an operation cell data processor. It comprises one or more operation cells 406, one or more arithmetic logic units 400, one or more input components 402, one or more output components 404, and permit logic 414. An example of permit logic is a microprocessor bus arbiter. The operation cells 406, arithmetic units 400, input components 402, and output components 404 are connected by communication means 408. The operation cells 406 are connected to permit logic 414 through communication means 416. Examples of communications means are discrete signal lines, point-to-point serial connections, traditional microprocessor buses, crossbar buses, Ethernet, and photonic communication links.

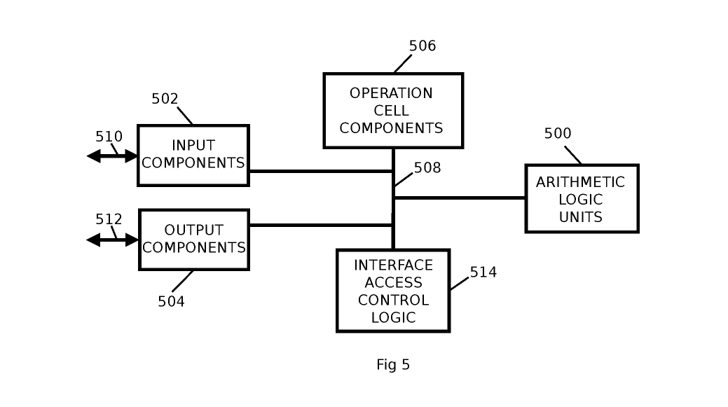

FIG. 5 illustrates an embodiment of an operation cell data processor. It comprises one or more operation cells 506, one or more arithmetic logic units 500, one or more input components 502, one or more output components 504, and interface access control logic 514. Examples of interface access control logic are microprocessor bus arbiter and crossbar bus access logic. The operation cells 506, arithmetic units 500, input components 502, and output components 504 are connected by communication means 508. Examples of communications means are discrete signal lines, point-to-point serial connections, traditional microprocessor buses, crossbar buses, Ethernet, and photonic communication links.

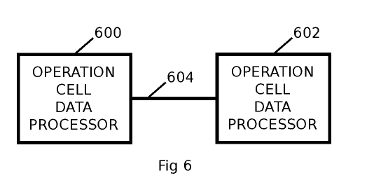

FIG. 6 illustrates an embodiment of an operation cell data processor network. It comprises two or more operation cell data processors (600 and 602) connected by communication means 604. Examples of communication means are discrete signal lines, point-to-point serial connections, traditional microprocessor buses, crossbar buses, Ethernet, and photonic communication links.

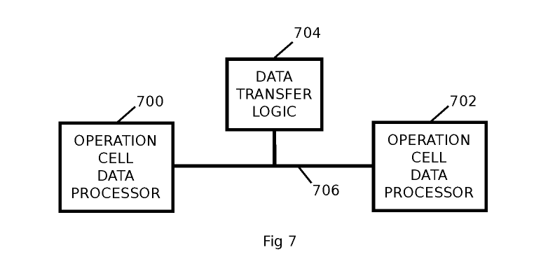

FIG. 7 illustrates an embodiment of an operation cell data processor network. It comprises two or more operation cell data processors (700 and 702), data transfer logic 704, and communication means 706. The communication means 708 connects the operation cell data processors (700 and 702) and the data transfer logic 704 together. Examples of data transfer logic are microprocessor bus arbiters, store-and-forward buffers, communication packet routing networks, bus bridges, and simple switches. Examples of communication means are discrete signal lines, point-to-point serial connections, traditional microprocessor buses, crossbar buses, Ethernet, and photonic communication links.

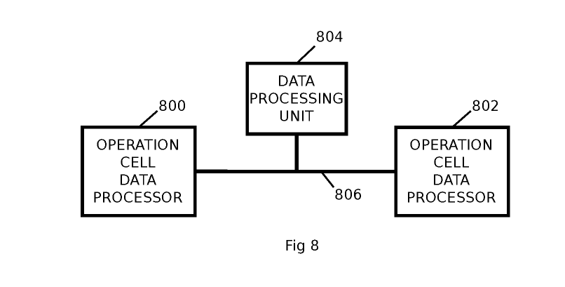

FIG. 8 illustrates an embodiment of an operation cell data processor network. It comprises two or more operation cell data processors (800 and 802), a data processing unit 804, and a communication means 806 that connects the operation cell data processors (800 and 802) and the data processing unit together. Examples of data processing units are operation cell data processors, microprocessors, microcontrollers, digital signal processors (DSPs), numeric co processors, special-purpose computation units, graphics processing units (GPUs), vector processors, cryptographic processors, and communication processors. Examples of communication means are discrete signal lines, point-to-point serial connections, traditional microprocessor buses, crossbar buses, Ethernet, and photonic communication links.

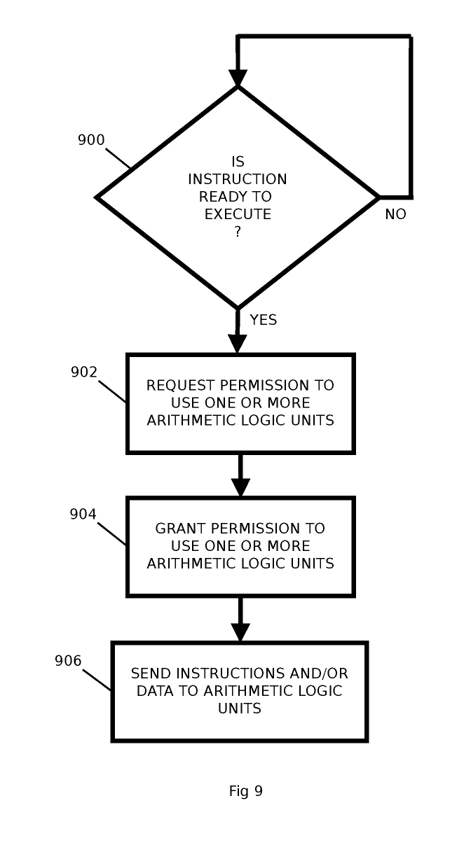

FIG. 9 illustrates an embodiment of a method of executing an instruction in an operation cell data processor. Step 900 is performed by an operation cell and determines if an instruction that is associated with the operation cell is ready to execute by inspecting the memories in an operation cell. If an instruction is not ready to execute, then step 900 is performed again. If an instruction is ready to execute, then the operation cell requests permission to use one or more arithmetic units in the system (step 902) from access permission logic. After step 902, the access permission logic grants permission for the operation cell to access an arithmetic logic unit (step 904). Once step 904 is completed, the operation cell sends instruction data to an arithmetic logic unit (step 906) for instruction execution.

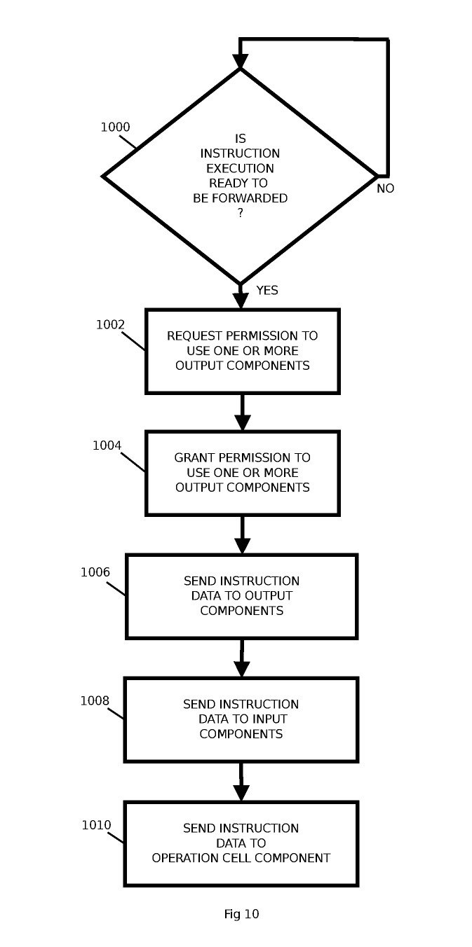

FIG. 10 illustrates an embodiment of a method of forwarding the responsibility of executing an instruction from a forwarding operation cell to a destination operation cell in a network of operation cell data processors. Step 1000 is performed by an forwarding operation cell and determines if the responsibility for executing an instruction associated with the operation cell should be forwarded to a destination operation cell in the system by examining the memories in the originating operation cell. If an instruction is not ready to be forwarded, then step 1000 is repeated. If an instruction is ready to be forwarded, then the forwarding operation cell requests permission from access permission logic to use one or more data processor output components from the forwarding operation cell's data processor access permission logic (step 1002). The access permission logic then grants the forwarding operation cell permission to use an output component (step 1004). The forwarding operation cell then sends instruction data to data processor output components (step 1006). The instruction data is then sent to data processor input components (step 1008). The instruction data is then sent to the destination operation cell (step 1010).

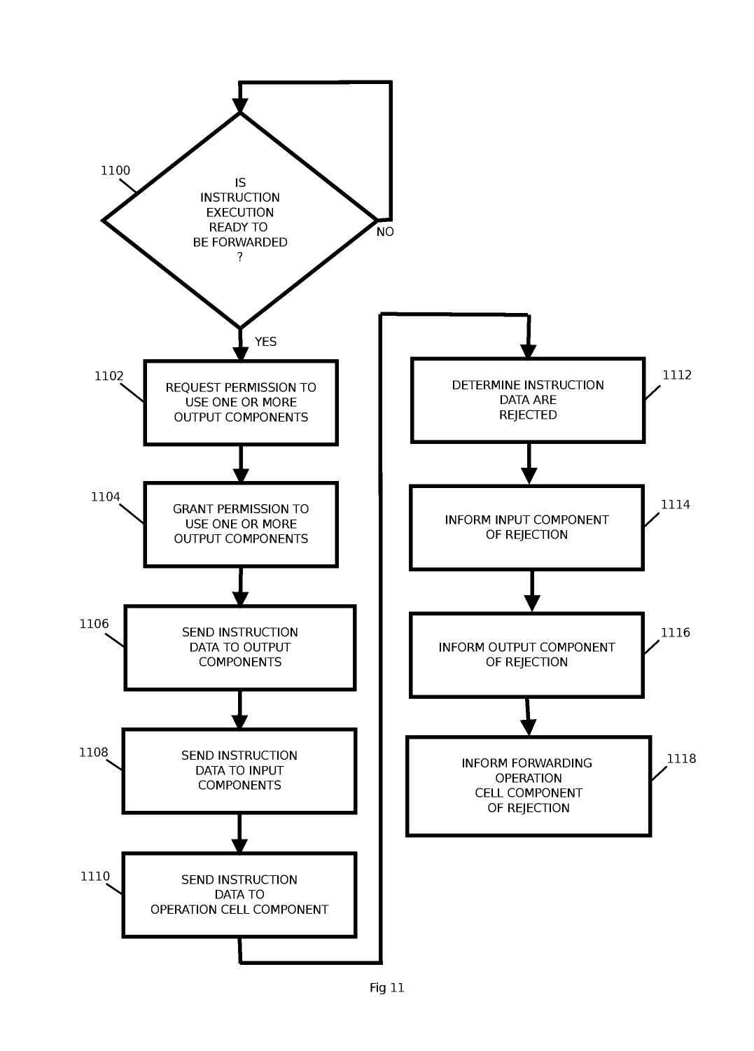

FIG. 11 illustrates an embodiment of a method of forwarding the responsibility of executing an instruction from a forwarding operation cell to a destination operation cell in a network of operation cell data processors where the destination operation cell rej ects the forwarding. Step 1100 is performed by a forwarding operation cell and determines if the responsibility for executing an instruction associated with the operation cell should be forwarded to a destination operation cell in the system by examining the memories in the originating operation cell. If an instruction is not ready to be forwarded, then step 1100 is repeated. If an instruction is ready to be forwarded, then the forwarding operation cell requests permission from access permission logic to use one or more data processor output components from the forwarding operation cell's data processor access permission logic (step 1102). The access permission logic then grants the forwarding operation cell permission to use an output component (step 1104). The forwarding operation cell then sends instruction data to data processor output components (step 1106). The instruction data is then sent to data processor input components (step 1108). The instruction data is then sent to the destination operation cell (step 1110). Next, the destination cell determines that it should rej ect the instruction data by examining its memories (step 1112). The destination cell then informs the input components of the rej ection (step 1114). Next, the input components inform the output components of the rejection (step 1116). Next, the output components inform the originating operation cell of the rej ection (step 1118).

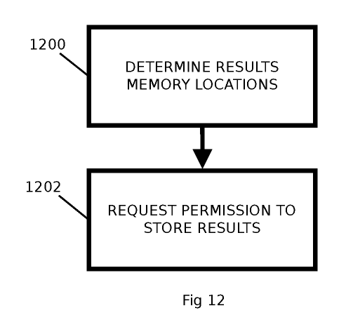

FIG. 12 illustrates an embodiment of a method for determining the storage locations of the results of an instruction execution in an operation cell data processor. First, an arithmetic logic unit determines the memory locations where the instruction execution results should be stored (step 1200). Then, the arithmetic logic unit requests permission to store to results (step 1202).

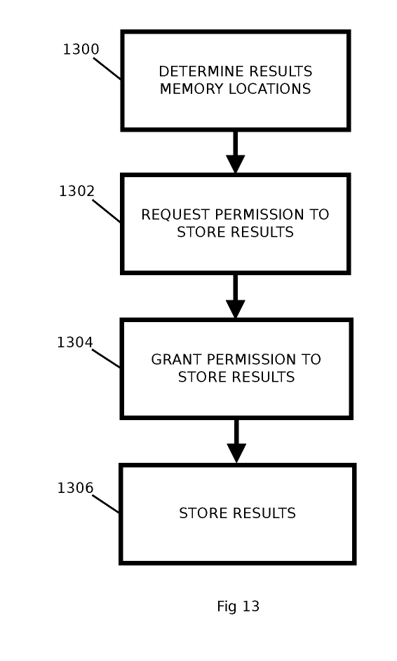

FIG. 13 illustrates an embodiment of a method for determining the storage locations of the results of an instruction execution in an operation cell data processor and storing the results. First, an arithmetic logic unit determines the memory locations where the instruction execution results should be stored (step 1300). Then, the arithmetic logic unit request permission to store to results (step 1302). Next, permission is granted for the results to be stored in the requested locations (step 1304). Next, the results are stored in the requested location (step 1306).

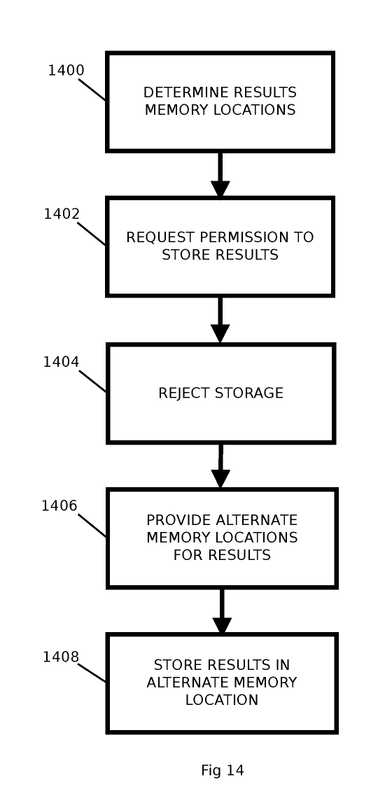

FIG. 14 illustrates an embodiment of a method for determining the storage location of the results of an instruction execution in an operation cell data processor and storing the results. First, an arithmetic logic unit determines the memory locations where the instruction execution results should be stored (step 1400). Then, the arithmetic logic unit requests permission to store to results (step 1402). Next, permission is rejected for the results to be stored in the requested locations (step 1404). Next, alternative storage locations for the results are determined (step 1406). Next, the results are stored in the alternative storage locations (step 1408).

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A data processor component comprising:
a. one or more memories to hold at least one of computer instructions, pieces of data, and pieces of data associated with said data processor component's past behavior.
b. logic to interface said data processor component to at least one external communication means,
c. logic having means to interface with said memories so as to determine when said computer instructions are ready to execute,
d. logic having means to interface with said external communication means logic and said memories so as to transfer at least one of said computer instructions, said pieces of data, and said pieces of data associated with said data processor component's past behavior,
f. logic having means to interface with
said external communication means logic,
said computer instruction execution determination logic, and
said memory transfer logic
so as to control the behavior of said data processor component.

2. A data processor component according to claim 1, further comprising a means to communicate between said memories and said behavior control logic.

3. A data processor comprising:
a. at least one arithmetic logic unit,
b. at least one input component,
c. at least one output component, and
d. a plurality of operation cell components each having means to interface with at least one of
said arithmetic logic units,
said input components,
said output components, and
said operation cell components.

4. A data processor according to claim 3, further comprising logic having means to interface to one or more said operation cell components to permit said operation cell components to send at least one of instructions and pieces of data to at least one of said arithmetic logic units, said input components, and said output components.

5. A processing unit according to claim 3, further comprising logic to control access to one or more of said interface means.

6. A network of data processors comprising a plurality of operation cell data processors each having means to communicate to at least one other said operation cell data processor in said network.

7. A network of data processors according to claim 6, further comprising logic with means to interface to one or more of said data processors to transfer data between at least two of said data processors.

8. A network of data processors according to claim 6, further comprising one or more data processing units with means to interface to one or more of said data processors in said network.

9. A method of executing an instruction in a data processor with a plurality of operation cell components comprising the steps of:
a. examining one or more memories in an operation cell component by said operation cell component to determine when said instruction is ready to execute,
b. requesting permission to use one or more arithmetic logic units in said data processor from access permission logic by said operation cells components,
c. granting permission for said operation cell component to send at least one of said instructions and said data to said arithmetic logic units by access permission logic,
d. sending at least one of said instructions and said data to said arithmetic logic units by said operation cell component.

10. A method of forwarding the execution responsibility of an instruction in a network of data processors with a plurality of operation cell components from one of said operation cell components in one of said data processors to another of said operation cell components comprising the steps of:
a. examining one or more memories in said originating operation cell component to determine when the forwarding the execution of one or more instructions in said memories of said originating operation cell component to said destination operation cell component is to be performed,
b. requesting permission to use one or more output components in said originating operation cell component's data processor from access permission logic,
c. granting permission for said originating operation cell component to use one or more of said output components by said access permission logic,
d. sending at least one of said instructions and data associated with said instructions to said output components,
e. sending at least one of said instructions and said data to an input component, and
f. sending at least one of said instructions and said data by said input component to a said operation cell component.

11. A method according to claim 10, further comprising:
a. determining the rejection of at least one of said instruction and said data by said receiving operation cell component by examining one or more memories in said receiving operation cell component,
b. informing said input component of said rejection by said receiving operation cell component,
c. informing said output component of said rejection by said input component, and
d. informing said forwarding operation cell component of said rejection by said output component.

12. A method of determining one or more memory locations of one or more instruction execution results in a data processor with a plurality of operation cell components comprising the steps of:
a. determining said memory locations of said results by an arithmetic logic unit, and
b. requesting permission to store said results in said memory locations from at least one of access permission logic and said operation cell components by said arithmetic logic unit.

13. A method according to claim 12, further comprising:
a. granting permission to store said results in said memory locations by at least one of said access permission logic and said operation cell components, and
b. storing said results in said memory locations.

14. A method according to claim 12, further comprising:
a. rejecting the storage of said results by said operation cell components,
b. providing alternative memory locations for said results by one of said arithmetic logic unit and said operation cell components, and
c. storing said results in said alternative memory locations.
